(19) United States
(12) Patent Application Publication
(10) Pub. No.: US 2021/0170696 A1
(43) Pub. Date: Jun. 10, 2021

(54) LASER-WELDABLE AND LASER-MARKABLE MOLDED ARTICLE

(71) Applicant: Polyplastics Co., Ltd., Tokyo (JP)

(72) Inventor: Kouichi Sakata, Fuji-shi, Shizuoka (JP)

(73) Assignee: Polyplastics Co., Ltd., Tokyo (JP)

(21) Appl. No.: 16/771,046

(22) PCT Filed: Dec. 10, 2018
(86) PCT No.: PCT/JP2018/045277

§ 371 Date: Jun. 9, 2020

(30) Foreign Application Priority Data
Dec. 12, 2017 (JP) 2017-237437

(51) Int. Cl. B29C 65/16

(52) U.S. Cl. CPC B29C 65/1677; B29K 2067/006

(57) ABSTRACT

A molded article that is used on a laser beam absorbing in laser welding side and that is possible to be marked by being irradiated with a laser beam, the molded article being composed of a resin composition containing 0.1 to 0.4 parts by mass of a carbon black per 100 parts by mass of a thermoplastic aromatic resin, the carbon black having a primary particle diameter of 20 to 40 nm and a DBP oil absorption of 100 cm³/100 g or more.

### TECHNICAL HELD

The present invention relates to a molded article capable of being both laser welded and laser marked.

### BACKGROUND ART

Molded articles composed of resin compositions are generally used in combination with other parts in the end. When using a molded article in combination with other parts, as a method of compounding, techniques such as double molding, adhesion, and welding, as well as fitting by physical structure such as screwing, snap fitting, and caulking are known. Among these, screwing and adhesion need additional members such as a screw and an adhesive, and fastening and adhesion steps using them take time and effort. Moreover, snap fitting and caulking need to provide a specific structure in a molded article, which imposes design restrictions. Also double molding needs a design idea in consideration of adhesion, and a special mold capable of positioning a primary molded article. Welding is useful in solving these disadvantages. Laser welding, vibration welding and ultrasonic welding are known as welding. Among these, vibration welding and ultrasonic welding have a possibility that the internal electronic parts and the like may be damaged by the vibration, and thus are not suitable for use in a case that houses precision electronic parts and the like inside. For such a use, laser welding, which does not cause vibration, is preferably employed.

Laser welding is a technique whereby a molded article made of a laser beam transmitting material and a molded article made of a laser beam absorbing material are superimposed and irradiated with a laser beam from the side of the laser beam transmitting molded article to generate heat at the interface with the laser beam absorbing molded article to weld the molded articles (see Patent Literature 1). A resin composition applied to a molded article for such a use is required to have properties of being weldable by laser beam irradiation (laser welding properties).

On the other hand, in molded articles, printing and drawing of product information and the like are often performed on the surface of molded articles in terms of design at the time of completion, display of information, parts identification during assembly, and the like. Moreover, when they are required to maintain visibility over a long term, laser marking may be used from a viewpoint of reliability (for example, see Patent Literature 2). Known modes in laser marking are a mode in which a non-colored or light-colored molded article is irradiated with a laser beam to have resin carbonized for black marking, a mode in which a compound that develops color by energy of a laser beam is added in advance and the compound is made to develop color for marking, and a mode in which a black or dark colored molded article is irradiated with a laser beam to sublime (decompose) a coloring agent (carbon black) to decolorize (expose background color of resin composition) for marking.

It is useful if there is a molded article achieving both the above-described laser welding and laser marking. Therefore, it is conceivable to add laser welding properties to a molded article colored in black with carbon black and markable by causing carbon black to sublime with a laser beam for decolorization. In this case, carbon black is used in laser marking for coloring and decolorizing purposes and in laser welding as a heat generating medium to give laser beam absorbency to the material.

### CITATION LIST

### Patent Literature

Patent Literature 1: Japanese Unexamined Patent Application Publication No. 2008-24946

Patent Literature 2: Japanese Unexamined Patent Application Publication No. 11-140284

### SUMMARY OF INVENTION

In laser marking, carbon black is preferably easy to sublime. However, subliming too easily, carbon black sublimes before a heating value necessary for melting the resin is obtained in laser welding, and thus adhesion by welding becomes difficult. To perform laser welding, it is necessary to leave carbon black at least until a temperature at which the resin melts. Note that, even with carbon black that is easy to sublime, there is also a way to keep the carbon black by adding a large amount until a heating value required for laser welding is obtained. However, from the viewpoint of laser marking, in order to sublime a large amount of carbon black for decolorization, it is necessary to increase the laser irradiation amount, accordingly. As a result, when the resin is excessively heated, discoloration of the resin portion occurs due to carbonization or deterioration, and the visibility of laser marking decreases. In particular, when laser marking is performed on a resin that is easily carbonized, such as an aromatic resin, there is a problem in that the visibility easily decreases due to the discoloration of the resin part.

As described above, laser marking and laser welding have a trade-off problem between visibility and adhesion intensity under the influence of carbon black. Therefore, both the laser marking properties and laser welding properties in one molded article cannot be achieved in the ordinary way.

The present invention has been made in view of the above-described conventional problem, and an object thereof is to provide a molded article that has both laser welding properties and laser marking properties.

### Solution to Problem

An aspect of the present invention for solving the above-mentioned problems is as follows.

(1) A molded article that is used on a laser beam absorbing side in laser welding and that is possible to be marked by being irradiated with a laser beam,

the molded article being composed of a resin composition containing 0.1 to 0.4 parts by mass of a carbon black per 100 parts by mass of a thermoplastic aromatic resin, the carbon black having a primary particle diameter of 20 to 40 nm and a DBP oil absorption of 100 cm³/100 g or more.

(2) The molded article according to the above (1), wherein the thermoplastic aromatic resin is a polybutylene terephthalate resin or a polyarylene sulfide resin.

(3) The molded article according to the above (1) or (2), further containing 20 to 200 parts by mass of an inorganic filler, and 10 to 30 parts by mass of an elastomer per 100 parts by mass of the thermoplastic aromatic resin.

### Advantageous Effects

According to the present invention, a molded article having both laser welding properties and laser marking properties is provided.

### DESCRIPTION OF EMBODIMENTS

A molded article according to the present embodiment is a molded article that is used on a laser beam absorption side in laser welding and that is possible to be marked by being irradiated with a laser beam, and is characterized by being composed of a resin composition containing 0.1 to 0.4 parts by mass of a carbon black having a primary particle diameter of 20 to 40 nm and a DBP oil absorption of 100 cm³/100 g or more per 100 parts by mass of a thermoplastic aromatic resin.

First, each component in the resin composition forming the molded article according to the present embodiment is described below.

[Thermoplastic Aromatic Resin]

The thermoplastic aromatic resin used in the present embodiment is a thermoplastic resin having an aromatic group in a structural unit. Targeting an aromatic resin that is a resin easy to carbonize, both the laser welding properties (used on a laser beam absorbing molded article side) and the laser marking properties of a molded article composed of a resin composition using such a resin are achieved. As such a resin, a polybutylene terephthalate resin (hereinafter, also referred to as “PBT resin”) and a polyarylene sulfide resin (hereinafter, also referred to as “PAS resin”) are mentioned and described below, but it is not limited to them in the present embodiment.

(Polybutylene Terephthalate Resin)

A PBT resin is a resin obtained by polycondensation of a dicarboxylic acid component containing at least a terephthalic acid or its ester-forming derivative (C1-6 alkyl ester, acid halide, etc.), and a glycol component containing at least an alkylene glycol having 4 carbon atoms (1,4-butanediol) or its ester-forming derivative (acetylated product, etc.). The PBT resin is not limited to a homopolybutylene terephthalate and may be a copolymer containing 60 mol % or more (particularly 75 mol % or more and 95 mol % or less) of a butylene terephthalate unit.

There is no particular limitation on the amount of a terminal carboxyl group of the PBT resin as long as the effects of the present invention are not impaired. The amount of the terminal carboxyl group of the PBT resin is preferably 30 meq/kg or less, more preferably 25 meq/kg or less.

The intrinsic viscosity (IV) of the PBT resin is preferably 0.65 to 1.20 dL/g. When a PBT resin having the intrinsic viscosity in the above-described range is used, the resulting resin composition is particularly excellent in mechanical properties and fluidity. On the contrary, when the intrinsic viscosity is less than 0.65 dL/g, excellent mechanical properties are not obtained, and when it exceeds 1.20 dL/g, excellent fluidity may not be obtained.

Moreover, the PBT resin having the intrinsic viscosity in the above-described range may have its intrinsic viscosity be adjusted by blending with a PBT resin having a different intrinsic viscosity. For example, a PBT resin having an intrinsic viscosity of 0.8 dL/g may be prepared by blending a PBT resin having an intrinsic viscosity of 0.9 dL/g with a PBT resin having an intrinsic viscosity of 0.7 dL/g. The intrinsic viscosity (IV) of PBT resins is measured, for example, in o-chlorophenol at a temperature of 35° C.

In the PBT resin, examples of the dicarboxylic acid component (comonomer component) other than terephthalic acid and ester-forming derivatives thereof include C8-14 aromatic dicarboxylic acids such as isophthalic acid, phthalic acid, 2,6-naphthalene dicarboxylic acid and 4,4′-dicarboxydiphenyl ether; C4-16 alkane dicarboxylic acids such as succinic acid, adipic acid, azelaic acid and sebacic acid; C5-10 cycloalkane dicarboxylic acids such as cyclohexane dicarboxylic acid; and ester-forming derivatives (C1-6 alkyl ester derivative, acid halide, and the like) of these dicarboxylic acid components. These dicarboxylic acid components may be used alone or in combination of two or more kinds.

Among these dicarboxylic acid components, C8-12 aromatic dicarboxylic acids such as isophthalic acid, and C6-12 alkane dicarboxylic acid such as adipic acid, azelaic acid and sebacic acid are more preferable.

In the PBT resin, examples of the glycol component (comonomer component) other than 1,4-butanediol include C2-10 alkylene glycol such as ethylene glycol, propylene glycol, trimethylene glycol, 1,3-butylene glycol, hexamethylene glycol, neopentyl glycol and 1,3-octanediol; polyoxyalkylene glycols such as diethylene glycol, triethylene glycol and dipropylene glycol; alicyclic diols such as cyclohexanedimethanol and hydrogenated bisphenol A; aromatic diols such as bisphenol A and 4,4′-dihydroxy biphenyl; C2-4 alkylene oxide adducts of bisphenol A such as ethylene oxide 2 mole adduct of bisphenol A and propylene oxide 3 mole adduct of bisphenol A; and ester-forming derivatives (acetylated products and the like) thereof. These glycol components may be used alone or in combination of two or more kinds.

Among these glycol components, C2-6 alkylene glycols such as ethylene glycol and trimethylene glycol, polyoxyalkylene glycol such as diethylene glycol, alicyclic diols such as cyclohexanedimethanol and the like are more preferable.

Examples of the comonomer component that may be used in addition to the dicarboxylic acid component and the glycol component include aromatic hydroxycarboxylic acids such as 4-hydroxy benzoic acid, 3-hydroxy benzoic acid, 6-hydroxy-2-naphthoic acid and 4-carboxy-4′-hydroxybiphenyl; aliphatic hydroxycarboxylic acid such as glycolic acid and hydroxy caproic acid; C3-12 lactones such as propiolactone, butyrolactone, valerolactone and caprolactone (such as ε-caprolactone); and ester-forming derivatives (C1-6 alkyl ester derivatives, acid halides, acetylated products, and the like) of these comonomer components.

(Polyarylene Sulfide Resin)

PAS resins are characterized by excellent mechanical properties, electrical properties, heat resistance and other physical and chemical properties, and good processability.

PAS resins are a polymer compound mainly composed of —(Ar—S)— (where Ar is an arylene group) as a repeating unit, and the present embodiment may use a PAS resin having a generally known molecular structure.

Examples of the above-described arylene group include p-phenylene group, m-phenylene group, o-phenylene group, substituted phenylene group, p,p′-diphenylene sulfone group, p,p′-biphenylene group, p,p′-diphenylene ether group, p,p′-diphenylene carbonyl group, and naphthalene group. The PAS resin may be a homopolymer composed of only the above repeating unit, or a copolymer containing the following different repeating units may be preferable from the viewpoint of processability and the like.

As the homopolymer, a polyphenylene sulfide resin having a p-phenylene sulfide group as a repeating unit, which uses a p-phenylene group as an arylene group, is preferably used. Further, as the copolymer, a combination of two or more types different from each other among arylene sulfide groups composed of the above-described arylene groups may be used, and among them a combination including a p-phenylene sulfide group and a m-phenylene sulfide group is particularly preferably used. Among these, one containing 70 mol % or more, preferably 80 mol % or more of a p-phenylene sulfide group is suitable from the viewpoint of physical properties, such as heat resistance, moldability and mechanical properties. Further, among these PAS resins, a high molecular weight polymer having a substantially straight chain structure obtained by polycondensation from a monomer composed mainly of a difunctional halogen aromatic compound may be particularly preferably used. Note that the PAS resin used in the present embodiment may be a mixture of PAS resins of two or more different molecular weights.

Note that other than the PAS resin having a straight chain structure, a polymer in which a branched structure or a cross-linked structure is partially formed by using a small amount of a monomer, such as a polyhaloaromatic compound having three or more halogen substituents, when polycondensation is performed, and a polymer obtained by heating a low molecular weight straight chain structural polymer at a high temperature in the presence of oxygen and the like to increase the melt viscosity by an oxidative cross-linking or a thermal cross-linking to have improved molding processability are mentioned.

The melt viscosity (310° C., shear rate 1216 sec⁻¹) of the PAS resin as a base resin used in the present embodiment is preferably 5 to 100 Pa·s including the case of the above-described mixed system.

[Carbon Black]

The carbon black according to the present embodiment has a primary particle size of 20 to 40 nm and a DBP oil absorption of 100 cm³/100 g or more. Then, 0.1 to 0.4 parts by mass of the carbon black is contained per 100 parts by mass of the thermoplastic aromatic resin. In the present embodiment, by including the specific amount of the specific carbon black as described above, both the laser welding properties and the laser marking properties are achieved.

Here, the molded article according to the present embodiment exhibits a blackish color by containing carbon black. In laser marking, a laser beam irradiation part has carbon black decomposed and sublimed for decolorization to have a large difference in color (luminance ratio) from a laser beam non-irradiation part (having a blackish color) to obtain sufficient visibility. Therefore, in order to obtain sufficient visibility in laser marking, it is important to use carbon black that is colored black by addition of a small amount and easily decomposed and sublimed by laser beam irradiation.

On the other hand, in laser welding, it is necessary to absorb a laser beam by coloring with carbon black in order to heat and melt resin efficiently. Therefore, when only the ease of sublimation of carbon black is pursued, sufficient laser welding properties may not be obtained. This is because when the sublimation of carbon black is too early, the heat generation necessary for welding is not obtained. That is, even carbon black that is optimal for laser marking is not always optimal for laser welding. Then, the present embodiment specifies the primary particle diameter, DBP oil absorption, and content of carbon black as described above and thus achieves both the laser marking properties and laser welding properties.

In the present embodiment, the primary particle diameter of carbon black is 20 to 40 nm. When the primary particle diameter of carbon black is less than 20 nm, sublimation by laser beam irradiation hardly occurs, and decolorization becomes insufficient, resulting in poor visibility of the laser marking portion. When the primary particle diameter of carbon black exceeds 40 nm, the coloration to a black color becomes disadvantageous, the jetness of the molded article (before marking) decreases (whiteness increases), and the luminance ratio between the laser marking portion and other portions becomes small, resulting in poor visibility. The primary particle diameter of carbon black is preferably 20 to 40 nm, more preferably 20 to 35 nm. Note that the primary particle diameter in the present embodiment is an average value obtained by measuring 3,000 unit particle diameters from an enlarged image acquired according to ASTM D3849 standard.

On the other hand, the DBP oil absorption is an index correlating with the size of the structure and reflects that the larger the value is, the larger the carbon black structure is. In the present embodiment, the DBP oil absorption of carbon black is 100 cm³/100 g or more. When it is less than 100 cm³/100 g, heat generation due to laser beam irradiation becomes insufficient, resulting in poor laser welding properties and laser marking properties. The DBP oil absorption is preferably 110 cm³/100 g or more, more preferably 120 cm³/100 g, further preferably 150 cm³/100 g. There is no particular limitation on the upper limit of the DBP oil absorption, but when the structure is too large, the manufacture itself becomes difficult, and it is disadvantageous in terms of the availability. Therefore, the DBP oil absorption is preferably 600 cm³/100 g or less, more preferably 500 cm³/100 g or less, further preferably 400 cm³/100 g or less (for example, 300 cm³/100 g or less). Note that the DBP oil absorption in the present embodiment is a value measured in accordance with JIS K6217-4:2008.

As carbon black, furnace black, acetylene black, ketjen black, and the like are known. Among them, ketjen black, which is porous and has a large specific surface area, is preferable because it sublimes easily.

In the present embodiment, 0.1 to 0.4 parts by mass of carbon black is contained per 100 parts by mass of the thermoplastic aromatic resin. When the amount of carbon black is less than 0.1 parts by mass, the luminance ratio between the laser beam irradiation part and the non-irradiation part is small in laser marking, resulting in poor laser marking properties, and it is difficult to secure a sufficient heating value in laser welding, resulting in insufficient adhesion strength. When the amount of carbon black exceeds 0.4 parts by mass, the heating value by laser beam irradiation necessary for sublimation of carbon black in laser marking increases. As a result, carbonization and discoloration of the resin part occur, and the luminance ratio to the laser beam non-irradiation part becomes small, resulting in poor visibility.

Here, it is also conceivable to secure sufficient laser welding properties by increasing the output of the laser beam while reducing the carbon black content. However, when the output of the laser beam is increased and if foreign matter is present in the molded article on the laser beam transmission side in laser welding, the foreign matter generates heat due to high-power laser beam irradiation, and the surroundings of the foreign matter may melt or foam. Therefore, it is preferable for stable production not to make the output of the laser beam too high. In order to secure the heating value necessary for melting the resin with low output laser beam, it is preferable to increase the carbon black content to a certain level or more so that the molded article on the laser beam absorbing side can absorb the laser beam efficiently. However, when the carbon black content is increased too much, the heating value by laser beam irradiation necessary for sublimation of carbon black becomes large in laser marking, and the visibility easily deteriorates due to carbonization or discoloration of the resin part. Then, in the present embodiment, the carbon black content is set as the above-described numerical range.

[Inorganic Filler]

The molded article according to the present embodiment preferably contains an inorganic filler to improve heat resistance and mechanical strength. There is no particular limitation on the type of the inorganic filler as long as the effects of the present application are not impaired. Examples thereof include glass fibers, glass flakes, glass beads, silica, talc, and mica, and glass fibers are particularly preferable. The fiber length of glass fibers (prior to preparation into a composition by melt-kneading etc.) is preferably 1 to 10 mm, and the diameter of glass fibers is preferably 5 to 20 μm.

In the present embodiment, it is preferable to contain 20 to 200 parts by mass, more preferably 30 to 150 parts by mass of the inorganic filler fiber per 100 parts by mass of the thermoplastic aromatic resin, from the viewpoint of improving heat resistance and mechanical strength.

[Elastomer]

The molded article according to the present embodiment preferably contains an elastomer to improve impact resistance. Examples of the elastomer include olefin-based elastomers, vinyl chloride-based elastomers, styrene-based elastomers, polyester-based elastomers, butadiene-based elastomers, acrylic rubber-based elastomers, urethane-based elastomers, polyamide-based elastomers, and silicone-based elastomers. In particular, ethylene ethyl acrylate (EEA), methacrylate-butylene-styrene (MBS) ethylene glycidyl methacrylate (EGMA), polytetramethylene glycol (PTMG)-based polyester elastomers, and the like may be used.

The present embodiment preferably contains 5 to 30 parts by mass, more preferably 10 to 20 parts by mass of the elastomer per 100 parts by mass of the thermoplastic aromatic resin, from the viewpoint of improving impact resistance.

[Other Components]

In the present embodiment, well-known additives generally added to thermoplastic resins and thermosetting resins may be blended in addition to the above-described components as long as the effects thereof are not impaired, such as a flash inhibitor, a release agent, a lubricant, a plasticizer, a flame retardant, a coloring agent such as a dye or a pigment, a crystallization accelerator, a crystal nucleating agent, various antioxidants, a heat stabilizer, a weather resistant stabilizer, a corrosion inhibitor and the like.

The molded article according to the present embodiment is formed by molding the resin composition described above. There is no limitation in particular as a method to manufacture the molded article according to the present embodiment, and a well-known method is employable. For example, the resin composition as described above may be introduced into an extruder, melt-kneaded and pelletized, and the pellet may be introduced into an injection molding machine equipped with a predetermined mold and manufactured by injection molding.

Next, laser welding and laser marking are sequentially described.

[Laser Welding]

As described above, in laser welding, a molded article made of a laser beam transmitting material (laser beam transmitting side) and a molded article made of a laser beam absorbing material (laser beam absorbing side) are superimposed. Then, they are irradiated with a laser beam from the side of the laser beam transmitting molded article, and the interface with the laser beam absorbing molded article is heated and welded. The molded article according to the present embodiment is a molded article used for the laser beam absorbing side. That is, in laser welding, a molded article on the laser beam transmission side is separately prepared, the molded article according to the present embodiment and the molded article on the laser beam transmission side are superimposed so that the surfaces to be welded are in contact with each other and are welded by irradiating with a laser beam from the molded article on the laser beam transmitting side.

In the present embodiment, a laser beam usable for laser welding includes a laser beam in the near infrared region. As the laser beam in a near infrared region, a laser emitting a beam with a wavelength of 900 to 1200 nm is particularly preferable, and a semiconductor laser and a YAG laser are preferable.

In laser welding, the irradiation conditions of the laser beam are not particularly limited and may be appropriately adjusted according to the combination of materials to be used and the shape of the molded article. The irradiation conditions need to be set to give energy necessary to melt the interface between the laser beam transmitting side molded article and the laser beam absorbing side molded article. In particular, the appropriate condition range changes depending on the laser beam transmittance and thickness of the laser beam transmitting side molded article. Those skilled in the art can find appropriate conditions by a limited number of trials in which the output of the laser beam and the irradiation time (scan speed) are mainly changed, while considering the specifications of apparatuses they have.

As an example, a 1 mm thick PBT resin molded article having a transmittance of 40% of laser beam with a wavelength of 940 nm is used for the laser beam transmitting side molded article, and a PBT resin molded article containing 0.2 mass % of carbon black is used for the laser beam absorbing side molded article, respectively. When laser welding is performed by irradiating with a laser beam having a wavelength of 940 nm at a scanning speed of 10 mm/sec, the output can be set to about 5 W to 15 W.

Note that in order to prevent problems such as unexpected melting and foaming in parts other than the welded part due to foreign matter or the like inside the molded article on the laser beam transmitting side as described above, it is preferable to set the output and irradiation time to be low so that the irradiation energy amount does not become too high.

[Laser Marking]

As described above, laser marking is performed by irradiating the molded article according to the present embodiment with a laser beam to decompose and sublime the carbon black contained in the molded article for decolorization. Therefore, when laser marking is performed on the molded article according to the present embodiment, the laser beam is scanned and irradiated so as to draw characters and figures to be marked. Alternatively, a masking layer is disposed between the light source and the molded article so that the laser beam reaches only the portion to be marked, and then the entire surface is irradiated with a laser beam. The characters and figures to be drawn are not particularly limited and selected arbitrarily.

Examples of a usable laser beam include a laser beam used for the above-described laser welding, such as Nd:YAG laser or Nd:YVO₄ laser.

In laser marking, the irradiation conditions of the laser beam are not particularly limited and may be appropriately adjusted according to the concentration of carbon black and the heat resistance of the resin contained in the material used for the target molded article. The irradiation conditions need to be set so that the carbon black is decomposed and sublimed to decolorize the molded article. As described above, when the heating value by the laser beam irradiation is too large, the visibility decreases due to carbonization or discoloration of the resin, so it is preferable to prevent the irradiation energy amount from becoming too high. Specifically, the amount of energy can be adjusted mainly by changing the output, the irradiation time (scanning speed) and the frequency of the laser beam. Since these can be easily changed by the setting of the irradiation apparatus, those skilled in the art can find appropriate conditions by a limited number of trials changing the combination of these, while considering the specifications of apparatuses they have.

As an example, when laser marking is performed using a PBT resin molded article containing 0.2% by mass of carbon black having a primary particle diameter of 21 nm and a DBP oil absorption of 175 cm³/100 g, and a laser beam having a wavelength of 1064 nm is irradiated with output of 2 W and Q-switching frequency of 20 kHz, the scan speed can be set to about 200 to 700 mm/sec.

### EXAMPLES

Hereinafter, the present embodiment will be more specifically described with reference to examples. However, the present embodiment is not limited to the following examples.

### Examples 1 to 4 and Comparative Examples 1 to 6

In each example and each comparative example, a resin composition was prepared by mixing and stirring a PBT resin, carbon black, an elastomer, and a glass fiber in parts (parts by mass) shown in Table 1. Details of each component shown in Table 1 are shown below.

PBT resin: (manufactured by Win Tech Polymer Ltd., intrinsic viscosity (IV)=0.88 dL/g, CEG=16 meq/kg)

Carbon black 1: (manufactured by Mitsubishi Chemical Corporation, furnace black, primary particle diameter 22 nm, DBP oil absorption 116 cm³/100 g)

Carbon black 2: (manufactured by Mitsubishi Chemical Corporation, furnace black, primary particle diameter 21 nm, DBP oil absorption 175cm³/100 g)

Carbon black 3: (manufactured by Lion Specialty Chemicals Corporation, ketjen black, primary particle diameter 30 nm, DBP oil absorption 396 cm³/100 g)

Carbon black 4: (manufactured by Mitsubishi Chemical Corporation, furnace black, primary particle diameter 15 nm, DBP oil absorption of 48 cm³/100 g)

Carbon black 5: (manufactured by Mitsubishi Chemical Corporation, furnace black, primary particle diameter 16 nm, DBP oil absorption of 62 cm³/100 g)

Carbon black 6: (manufactured by Mitsubishi Chemical Corporation, furnace black, primary particle diameter 24 nm, DBP oil absorption of 42cm³/100 g)

Carbon black 7: (manufactured by Mitsubishi Chemical Corporation, furnace black, primary particle diameter 50 nm, DBP oil absorption 115cm³/100 g)

Elastomer: (manufactured by NUC Corporation, NUC-6570 (ethylene-ethyl acrylate copolymer)

Glass fiber: (manufactured by Nippon Electric Glass Co., Ltd., ECSO3T-187, average fiber diameter 13 rim, average fiber length 3 mm)

The primary particle diameter and the DBP oil absorption of carbon black 1 to 7 are shown in Table 2 below.

TABLE 1

| | Examples | | | | Comparative Examples | | | | | |
|---|---|---|---|---|---|---|---|---|---|---|
| | 1 | 2 | 3 | 4 | 1 | 2 | 3 | 4 | 5 | 6 |
| PBT resin | 100 | 100 | 100 | 100 | 100 | 100 | 100 | 100 | 100 | 100 |
| Carbon black 1 | 0.25 | 0.17 | — | — | — | — | — | — | 0.08 | 0.50 |
| Carbon black 2 | — | — | 0.25 | — | — | — | — | — | — | — |
| Carbon black 3 | — | — | — | 0.25 | — | — | — | — | — | — |
| Carbon black 4 | — | — | — | — | 0.25 | — | — | — | — | — |
| Carbon black 5 | — | — | — | — | — | 0.25 | — | — | — | — |
| Carbon black 6 | — | — | — | — | — | — | 0.25 | — | — | — |
| Carbon black 7 | — | — | — | — | — | — | — | 0.25 | — | — |
| Elastomer | 17 | 17 | 17 | 17 | 17 | 17 | 17 | 17 | 17 | 17 |
| Glass fiber | 50 | 50 | 50 | 50 | 50 | 50 | 50 | 50 | 50 | 50 |
| Laser marking properties | 2.60 | 2.56 | 2.73 | 2.85 | 2.37 | 2.44 | 2.37 | 2.43 | 2.07 | 2.18 |
| (Luminance ratio) | | | | | | | | | | |
| L-value of molded article | 22.97 | 25.63 | 23.31 | 23.11 | 23.07 | 23.08 | 24.67 | 25.97 | 32.42 | 20.23 |
| Laser welding strength | 26.6 | 24.0 | 25.1 | 25.0 | 26.2 | 26.3 | 24.5 | 23.8 | 12.5 | 28.5 |
| (MPa) | | | | | | | | | | |

TABLE 2

| | Primary particle | DBL oil absorption |
|---|---|---|
| | diameter (nm) | (cm³/100 g) |
| Carbon black 1 | 22 | 116 |
| Carbon black 2 | 21 | 175 |
| Carbon black 3 | 30 | 396 |
| Carbon black 4 | 15 | 48 |
| Carbon black 5 | 16 | 62 |
| Carbon black 6 | 24 | 42 |
| Carbon black 7 | 50 | 115 |

[Evaluation]

With the obtained resin composition, a flat plate-shaped molded article of 70 mm×50 mm×3 mm was prepared, and laser marking was evaluated.

(1) Laser Marking Properties (Luminance Ratio)

The obtained molded article was subjected to laser marking at a combination of scan speed and Q-switching frequency conditions shown below. After laser marking, based on an image obtained by scanning a marking area and a non-marking area with LiDE210 manufactured by Canon Inc., the luminance of the histogram was acquired using Photoshop Elements manufactured by Adobe System Co., Ltd. Then, the luminance ratio (maximum luminance value of the marking area/luminance value of the non-marking area) was calculated from the highest luminance value of the marking area and the luminance value of the non-marking area. The measurement results are shown in Table 1.

(Laser Marking Condition)

Laser marking device: MD-V9900A manufactured by KEYENCE CORPORATION

Laser type: Nd:YVO4 laser, wavelength 1064 nm

Q-switching frequency: 0, 10, 20, 30, 40, 50, 60, 70, 80, 90, 100 Hz

Laser output: 2 W

Scanning speed: 100, 200, 300, 400, 500, 600, 700, 800, 900, 1000 mm/s

(2) L-Value of Molded Article (Brightness)

L-value of the manufactured molded article was measured using Spectrophotometer SE6000 manufactured by Nippon Denshoku Industries Co., Ltd. The measurement results are shown in Table 1.

(3) Laser Welding Strength

The manufactured molded article was used on the laser beam absorbing side and a 80 mm×20 mm×1 mm strip-shaped molded article made of Duranex (registered trademark) 3300 EF2001 (non-colored PBT resin composition containing 30% by mass of glass fiber) manufactured by Win Tech Polymer Ltd. was used on the laser beam transmission side, and both were superimposed. Then, in that state, laser welding was performed under the laser welding conditions shown below. Subsequently, the breaking strength was measured at a test speed of 10 mm/min using universal testing machine autograph AG-X manufactured by SHIMADZU CORPORATION to calculate welding strength. The results are shown in Table 1.

(Laser Welding Condition)

Laser welding device: FD-2430 manufactured by Fine Device Co., Ltd.

Laser type: Nd:YAG laser (wavelength: 940 nm)

Irradiation rate: 10 mm/sec

Irradiation diameter: φ1.6 mm

Irradiation distance: 4 mm

Laser power: 5 W to 13 W

Note that “Laser power: 5 W to 13 W” means that a condition in which the highest adhesion strength is obtained among laser welding under multiple conditions where the output was changed within the range of 5 W to 13 W for each example is adopted as the evaluation condition of “laser welding strength”. This considers that, as described above, the optimum laser irradiation conditions in laser welding vary depending on the material because carbon black contained in the laser beam absorbing side molded article is decomposed too much depending on the irradiation condition of the laser beam and thus it is difficult to obtain the heating value necessary for the laser welding.

From Table 1, the molded articles of Examples 1 to 4 all have a high luminance ratio and good laser marking properties. Moreover, it is understood that the laser welding strength is also excellent and both the laser marking properties and the laser welding properties are achieved. On the other hand, Comparative Examples 1 to 6 are inferior in at least one of the laser marking properties and the laser welding strength, and it is not possible to achieve both of their properties.

1. A molded article that is used on a laser beam absorbing side in laser welding and that is possible to be marked by being irradiated with a laser beam, the molded article being composed of a resin composition comprising 0.1 to 0.4 parts by mass of a carbon black per 100 parts by mass of a thermoplastic aromatic resin, the carbon black having a primary particle diameter of 20 to 40 nm and a DBP oil absorption of 100 cm^{3/}100 g or more.

2. The molded article according to claim 1, wherein
the thermoplastic aromatic resin is a polybutylene terephthalate resin or a polyarylene sulfide resin.

3. The molded article according to claim 1, further comprising 20 to 200 parts by mass of an inorganic filler and 10 to 30 parts by mass of an elastomer per 100 parts by mass of the thermoplastic aromatic resin.

4. The molded article according to claim 2, further comprising 20 to 200 parts by mass of an inorganic filler and 10 to 30 parts by mass of an elastomer per 100 parts by mass of the thermoplastic aromatic resin.
